(19) United States
(12) Patent Application Publication
(10) Pub. No.: US 2008/0080536 A1
(43) Pub. Date: Apr. 3, 2008

(54) MEDIA ACCESS CONTROL LAYER BRIDGING OF A REAL COMMUNICATION DEVICE TO A SIMULATED NETWORK

(75) Inventors: Harshal Shantanu CHHAYA, Plano, TX (US); Shantanu KANGUDE, Dallas, TX (US); Ariton E. XHAFA, Plano, TX (US); Xiaolin LU, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/865,971

(22) Filed: Oct. 2, 2007

Related U.S. Application Data
(60) Provisional application No. 60/827,761, filed on Oct. 2, 2006.

(51) Int. Cl. H04L 12/28

(52) U.S. Cl. 370/401

(57) ABSTRACT

Systems and methods for media access control (MAC) layer bridging of a real communication device to a simulated network are described herein. Some illustrative embodiments include a communication network bridge that includes a processor that executes simulation software that implements a simulated network and further implements a simulated network interface that provides a communication path to the simulated communication network, and a real network interface that provides a communication path to a real communication network. A first media access control (MAC) layer message that conforms to a protocol associated with the real communication network is received by the real network interface from across the real communication network. The first MAC layer message is transformed by a first transformation operation into a second MAC layer message that is forwarded to a physical (PHY) layer of the simulated network interface.

### CROSS-REFERENCE TO RELATED APPLICATIONS

The present application claims the benefit of provisional application Ser. No. 60/827,761, filed Oct. 2, 2006 and entitled “Method and Devices to use Layer 2 Bridging for Real Time and Protocol True interactions between Discrete Event Simulations and Real Testbeds,” which is herein incorporated by reference.

### BACKGROUND

As communications networks have continued to increase in size and complexity, network communication equipment designers have found themselves faced with testing requirements that have also continued to increase in size and complexity. The size and complexity of even a small portion of a communication network can make replicating such a network or network segment difficult or impractical. To deal with these issues, designers needing to test and exercise prototype network communication equipment have resorted to using computer simulations to represent large portions of one or more communications networks that interact with the prototype equipment. Such simulation/prototype networked combinations, however, have been limited to bridges between the real and simulated domains that operate at the network layer or above (layer 3 or higher of the 7-layer network model). As a result, prototype components, circuits and software used to implement the lower layers of the network model, such as for example the data link layer (layer 2 of the 7-layer network model), cannot be fully exercised and tested using simulations that interact with a prototype using a layer 3 bridge.

### SUMMARY

Systems and methods for media access control (MAC) layer bridging of a real communication device to a simulated network are described herein. Some illustrative embodiments include a communication network bridge that includes a processor that executes simulation software that implements a simulated network and further implements a simulated network interface that provides a communication path to the simulated communication network, and a real network interface that provides a communication path to a real communication network. A first media access control (MAC) layer message that conforms to a protocol associated with the real communication network is received by the real network interface from across the real communication network. The first MAC layer message is transformed by a first transformation operation into a second MAC layer message that is forwarded to a physical (PHY) layer of the simulated network interface.

Other illustrative embodiments include a system that includes a communication device comprising a first real network interface, a computer system (the computer system including a processor executing simulation software that implements a simulated communication network, a second real network interface coupled to the processor, and a communication network bridge that includes at least part of the second real network interface and further includes a message bridging function implemented at least in part by the simulation software), and a real communication network that couples to both the first and second real network interfaces. The communication network bridge provides transparent bridging of a first media access control (MAC) layer message exchanged between the communication device and a physical (PHY) layer of a simulated network interface to the simulated communication network.

Yet further illustrative embodiments include a method that includes executing software that implements a simulated communication network and a simulated network interface to the simulated communication network, receiving a first media access control (MAC) layer message from a physical (PHY) layer of the simulated network interface, transforming the first MAC layer message into a second MAC layer message conforming to a protocol associated with a real communication network, and transmitting the second MAC layer message across the real communication network to a real communication device.

### BRIEF DESCRIPTION OF THE DRAWINGS

For a detailed description of illustrative embodiments of the invention, reference will now be made to the accompanying drawings in which:

FIG. 1A shows a communication device bridged to a simulated communication network, in accordance with at least some illustrative embodiments;

FIG. 1B shows a simplified block diagram of the hardware of the communication device of FIG. 1A, in accordance with at least some illustrative embodiments;

FIG. 2 shows a seven-layer network model, used at least in part in at least some illustrative embodiments;

FIG. 3A shows a block diagram of the MAC bridge of FIG. 1A, in accordance with at least some illustrative embodiments;

FIG. 3B shows a functional block diagram of the communication device of FIG. 1A, in accordance with at least some illustrative embodiments;

FIG. 4A shows encapsulation of MAC layer messages for transmission over an intervening transparent communication network, in accordance with at least some illustrative embodiments;

FIG. 4B shows MAC layer header substitution for transmission over an intervening transparent communication network, in accordance with at least some illustrative embodiments;

FIG. 5A shows a method for bridging a MAC layer message to a communication device from a simulated communication network, in accordance with at least some illustrative embodiments; and

FIG. 5B shows a method for bridging a MAC layer message from a communication device to a simulated communication network, in accordance with at least some illustrative embodiments.

### NOTATION AND NOMENCLATURE

Certain terms are used throughout the following discussion and claims to refer to particular system components. This document does not intend to distinguish between components that differ in name but not function. In the following discussion and in the claims, the terms “including” and “comprising” are used in an open-ended fashion, and thus should be interpreted to mean “including but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more hardware and/or software components, and may be used to refer to either a real or simulated device, such as, for example, a network, network interface and/or network bridge; a portion of a network, network interface and/or network bridge; or a combination of networks, network interfaces and/or network bridges. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

With the proliferation of large-scale communication networks, it has become increasingly difficult to test prototype communication devices in test environments that accurately replicate the actual conditions encountered when such a communication device interacts with a large-scale communication network that is also interacting with a large number of other communication devices. One approach to creating a test environment that replicates these conditions is to couple a prototype communication device to a computer system that executes software that simulates a communication network and the communications devices (other than the real prototype being tested) that interact with the network.

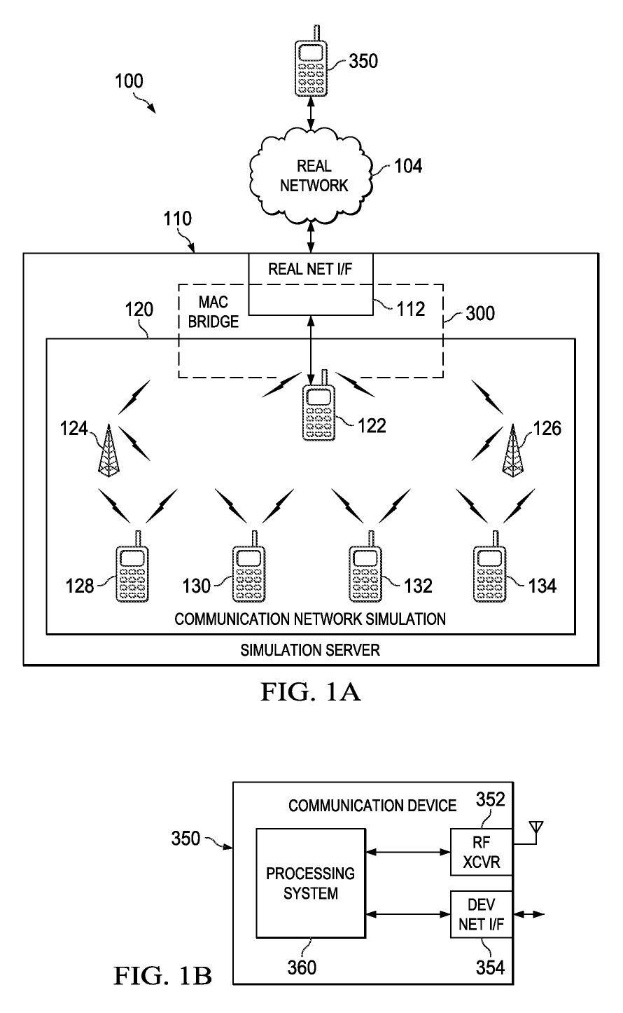

FIG. 1A shows a system 100 that implements such a testing environment, in accordance with at least some illustrative embodiments. Network 104 couples communication device 350 to network interface (Net I/F) 112 of simulation server 110, thus providing a communication path between communication device 350 and communication network simulation 120 (via MAC bridge 300, discussed below). Simulation server 110 executes simulation software that implements communication network simulation 120. Communication network simulation 120 simulates the various elements of a communication network that interact with each other and with communication device 350 (via the communication path through network 104). For example, in the illustrative embodiment of FIG. 1A a cellular telephone network is simulated by communication network simulation 120. The simulation shown includes simulated terrestrial base stations 124 and 126, as well as simulated communication devices (e.g., cellular telephones) 128 through 134. Communication network simulation 120 also includes simulated communication device 122, which acts as a proxy for real communication device 350.

FIG. 1B shows a simplified block diagram of the hardware of the communication device 350 of FIG. 1A (e.g., a cellular telephone), in accordance with at least some illustrative embodiments. The communication device 350 includes a processing system 360 coupled to RF transceiver (RE Xcvr) 352 and device network interface (Dev Net I/F) 354. Communication device 350 couples to network 104 via device network interface 354. When communication device 350 is in a test mode, communication data generated and/or processed by processing system 360 is routed through device network interface 354 (e.g., an Ethernet interface), instead of through the radio frequency transceiver 352, which is used when the communication device is not in a test mode.

When operating in a test mode, communication device 350 sends and receives communication data to and from the communication network simulation 120 of FIG. 1A, specifically to and from simulated communication device 122. Simulated communication device 122, acting as a proxy for communication device 350, simulates the by-passed hardware elements of communication device 350. In this manner, the simulated communications network and the simulated elements within the network appear to communication device 350 as a real network over which real communication devices are interacting. Similarly, simulated (proxy) communication device 122 allows communication device 350 to interact with the simulation and the other simulated communication devices as if communication device 350 were another simulated communication device.

By interfacing real communication device 350 with the network and devices of communication network simulation 120, it is possible to test communication device 350 under conditions and scenarios that might otherwise be impractical or impossible to replicate using real networks and real devices in a laboratory environment. The number of devices and the size of the communication network are generally only limited by the processing capacity of simulation server 110, and by the software simulation limits of communication network simulation 120.

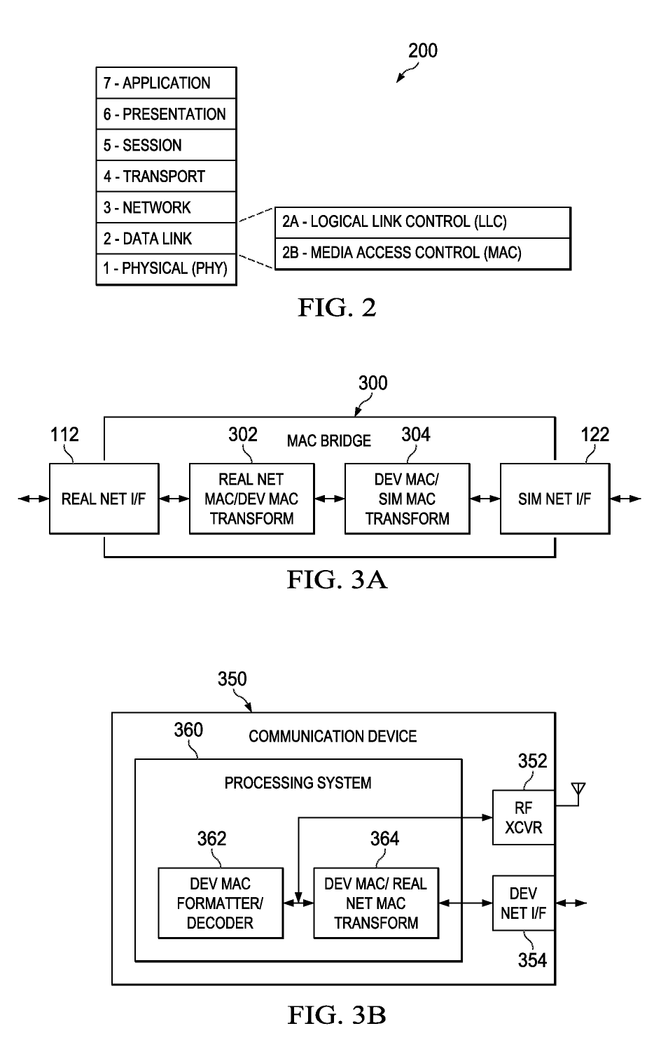

In order to improve the effectiveness of the testing of communication device 350, and to exercise as much of the hardware and software of the device as possible, the interface between communication device 350 and simulated communication device 122 is implemented at what is known as the media access control (MAC) layer. As is well known to those of ordinary skill in the art, communication between devices across communication networks are frequently structured and formatted according to what is sometimes referred to as the seven-layer network model. See, for example, 1 Douglas E. Corner, Internetworking with TCP/IP, Principles, Protocols and Architecture 139-158 (2d ed. 1991). FIG. 2 illustrates such a model. As data is formatted and forwarded to each subsequent upper or lower layer, headers are removed or added. Thus, for example, data formatted for output to a network at the application layer (layer 7) is subsequently encapsulated at layer 6 within another message with its own layer-specific header.

Each layer repeats this process, until a message emerges at the physical (PHY) layer with multiple distinct headers and layers, each with a different function. For example, headers introduced at the data link layer may include addressing information that allows a message to be sent from the device originating the message to another device directly connected to the same network as the originating device. Other layers further up the chain may provide other information, such as addressing corresponding to the ultimate destination of the message (e.g., a TPC/IP address). Thus, for example, in a TCP/IP network implemented using an underlying Ethernet cabling, routing across the network occurs at the network and transport layers (layers 3 and 4) according to protocols defined for TCP/IP, whereas routing within a network segment occurs at the data link layer (layer 2) according to protocols defined for Ethernet.

As can be seen in FIG. 2, the data link layer within the seven-layer model is further sub-divided into two sub-layers, the logical link control (LLC) layer, and the media access control (MAC) layer. The MAC layer of FIG. 2 is the layer that interacts most directly with the underlying physical hardware (i.e. the PHY layer) that provides actual communication signaling (e.g., the electrical signaling sent to and received from an Ethernet interface, or the RF transmit and receive signals sent and received by a cellular telephone transceiver). Although FIG. 2 shows the relationship between the MAC layer and the PHY layer within the context of a seven-layer model, those of ordinary skill in the art will recognize that other implementations, with similar MAC and PHY layers, that include more or less total layers may also be suitable for use in the embodiments described herein, and all such other implementations are within the scope of the present disclosure.

Because the MAC layer is the layer that most directly interacts with the PHY layer, the hardware and/or software that implements the MAC layer is frequently the most complex, when compared to hardware and/or software that implements other layers. As a result, it is desirable to thoroughly test the interaction of the MAC and PHY layers. In order to achieve this, the interaction between communication device 350 and simulated communication device 122 of FIG. 1A is implemented such that MAC layer messages to and from real communication device 350 are transparently exchanged, across network 104, network interface 112 and MAC bridge 300, with the simulated PHY layer implemented by simulated communication device 122. The mechanisms used to exchange the MAC layer messages are invisible to both real communication device 350 and simulated communication device 122, enabling the two devices to operate as a single integrated device that interacts with the other elements of communication network simulation 120.

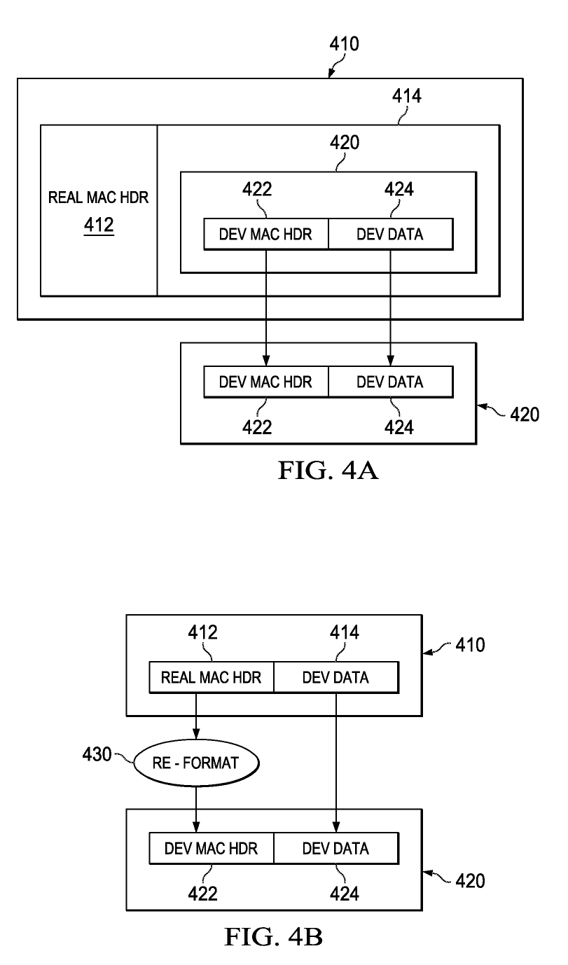

FIG. 3A shows a block diagram of the MAC bridge 300 of FIG. 1A, in accordance with at least some illustrative embodiments. As can be seen in both FIG. 1A and FIG. 3A, MAC bridge 300 of the illustrative embodiment shown comprises both hardware elements (real network interface 112) and software elements (real network MAC/device MAC transform 302, device MAC/simulation MAC transform 304, and simulated network interface 122). MAC layer messages received by real network interface 112 are forwarded to real network MAC/device MAC transform 302, which reconstructs the original device MAC layer message transmitted from across real network 104 of FIG. 1A (i.e., originating from communication device 350). In at least some illustrative embodiments, the real network MAC layer message is transformed into the original device MAC layer message by unencapsulating the device MAC message from within a second MAC message that conforms to the protocol of the real communication network (e.g., real network 104 of FIG. 1A). This decapsulation is shown in FIG. 4A. Real MAC layer message 410 includes a real MAC header 412 and a data section 414. Data section 414 includes device MAC layer message 420, which includes device MAC header 422 and device data section 424. The decapsulation of device MAC message 420 is achieved by extracting device MAC message 420 from within data section 414 of real MAC layer message 410.

In other illustrative embodiments, the transformation of real network MAC layer message 410 into the original device MAC layer message is achieved through a header substitution process, as shown in FIG. 4B. A re-formatting process 430 (implemented, for example as part of real network MAC/device MAC transform 302 of FIG. 3A) reads in real MAC header 412 of real network MAC layer message 410 and regenerates the original device MAC header 422 in conformance with the protocol associated with the MAC layer of the simulated network of network communication simulation 120 of FIG. 1A. Real data section 414 of real network MAC layer message 410 is copied without modification into device data section 424 of device MAC layer message 420. Some header fields, such as for example source and destination address fields, may be transformed using a series of lookup tables that are configured prior to executing the simulation and that correlate addresses within the simulated network to address ranges used by real network interface 112 (FIG. 1A) and device network interface 354 (FIG. 1B). Other techniques for transforming and substituting fields within real MAC header 412 and device MAC header 422 will become apparent to those of ordinary skill in the art, and all such techniques are within the scope of the present disclosure.

Referring again to FIG. 3A, once a received real network MAC layer message has been transformed into a device MAC layer message by transform 302, the device MAC layer message is forwarded to device MAC/simulation MAC transform 304, which converts the device MAC layer message into a format that is compatible with communication network simulation 120 of FIG. 1A. In at least some illustrative embodiments, this transformation is necessary due to the fact that the simulation may not format MAC layer messages, exchanged between simulated devices, which completely conform to the protocol of the simulated communication network. This is due to the fact that the simulation message may be optimized to eliminate redundant or unused fields so as to improve the performance of the simulation. The optimized simulation MAC layer packet produced by transform 304 is forwarded to simulated network interface 122, where it is sent out to the simulated communication network of communication network simulation 120.

MAC layer messages that are received by simulated network interface 122 are processed in a manner similar to that described above, but with the steps reversed in order and the functional inverse of the previously described transformation performed on the received simulation MAC layer messages. Thus device MAC/simulation MAC transform 304 transforms simulation MAC layer messages received by simulated network interface 122 into device MAC layer messages that are forwarded to real network MAC/device MAC transform 302. Transform 302 similarly transforms device MAC layer messages destined for the real network in to real network MAC layer messages (either via encapsulation or via the functional inverse of the substitution previously described), which are forwarded to real network interface 112 for transmission across real network 104 of FIG. 1A.

Communication device 350 also performs transformations similar to those performed by real network MAC/device MAC transform 302. Referring to FIG. 3B, processing system 360 comprises device MAC formatter/decoder 362 and device MAC/real network MAC transform 364. In at least some illustrative embodiments, formatter/decoder 362 and transform 364 are implemented as software programs that execute within processing system 360. During normal operation (i.e., non-test operation) of communication device 350, device MAC layer messages formatted by formatter/decoder 362 are forwarded to RF transceiver 352 for transmission to a real wireless communication network (e.g., a cellular telephone network), and device MAC layer messages received by RF transceiver 352 are forwarded to, decoded by, formatter/decoder 362.

When communication device 350 is operated in a test mode, device MAC layer messages are not sent to RF transceiver 352, and are instead forwarded to device MAC/real network MAC transform 364, which transforms the device MAC layer messages into real network MAC layer messages in the same manner as described with regard to transform 302 of FIG. 3A (i.e., using either encapsulation or header field substitution). The resulting real network MAC layer message is forwarded to device network interface 354 of FIG. 3B, which transmits the message across communication network 104 of FIG. 1A to real network interface 112 of simulation server 110 for further processing by MAC bridge 300. Likewise, when communication device 350 of FIG. 3B is operated in a test mode, real network MAC layer message received from simulation server 110 by device network interface 354 are forwarded to device MAC/real network MAC transform 364, which regenerates the device MAC layer message and forwards it to device MAC formatter/decoder to be decoded.

Because the bridging of communication device 350 with communication network simulation 120 is performed at the MAC layer, some timing issues need to be addressed. Specifically, many of the timeouts associated with the transmission and reception of MAC layer messages are much shorter than the execution time required for communication network simulation 120 to communicate and interact with communication device 350. For example, at least some MAC layer timeouts occur within a few microseconds, whereas communication network simulation 120 may require several milliseconds to respond to a MAC layer message from communication device 350. In at least some illustrative embodiments, communication device 350 is operated at a slower speed (i.e., the internal clock of the digital logic is operated at a lower frequency), such that the MAC layer timeouts are longer than the worst-case execution cycle of communication network simulation 120 when responding and/or interacting with communication device 350. In at least some illustrative embodiments, the clock speed of communication device 350 is slowed down by a factor of 100, while in other illustrative embodiments the clock speed is slowed down by a factor of 1000. Other clock speeds and criteria for determining the reduction in the clock speed of communication device 350 relative to the execution speed of communication network simulation 120 will become apparent to those of ordinary skill in the art, and all such clock speeds and criteria are within the scope of the present disclosure.

In addition to slowing down the clock of communication device 350 to allow communication network simulation 120 enough time to respond to messages from communication device 350, in at least some illustrative embodiments communication network simulation 120 also includes a pacing mechanism. The pacing mechanism prevents communication network simulation 120 from advancing simulated time (as represented by the simulation software) at a pace that is faster than the equivalent passage of time as determined by communication device 350 (i.e., as determined by the clock speed of device 350). The pacing described may be achieve by pausing the simulation between simulated time intervals to make sure that each interval progresses no faster than a pre-configured real time interval. The real time interval may be an actual time interval (e.g., 100 milliseconds), or a scaled real time interval (e.g., 10 seconds) to account for scaling used to slow down the clock speed of communication device 350. In each case the simulated time interval is synchronized to match the passage of time as measured by communication device 350. Other techniques for synchronizing the passage of time within communication network simulation 120 and the passage of time as measured by communication device 350 will become apparent to those of ordinary skill in the art, and all such techniques are within the scope of the present disclosure.

Although the embodiment shown in FIG. 1A includes a single communication device 350 interacting with a single simulated network interface 122, other illustrative embodiments may include multiple real communication devices, each interacting with a simulated network device via one or more MAC bridges. Further, in at least some illustrative embodiments, communication network simulation 120 includes multiple communication networks, which may each simulate the same type of network (e.g., a cellular telephone network), or a combination of several different types of networks coupled to, and interacting with, each other (e.g., a cellular telephone network coupled to both a wired telecommunication network and the Internet). Also, communication device 350 and simulated network interface 122 are not limited to user communication devices, such as the cellular telephones (real and simulated) shown in FIG. 1A, but may also include other devices such as, for example, a terrestrial base station. In such an embodiment, communication device 350 would include the base station hardware, and simulated network interface 122 would represent device 350 as a terrestrial base station within network communication simulation 120. Other combinations of different numbers, and different types, of networks and communication devices will become apparent to those of ordinary skill in the art, and all such combinations, numbers, and types of networks and communication devices are within the scope of the present disclosure.

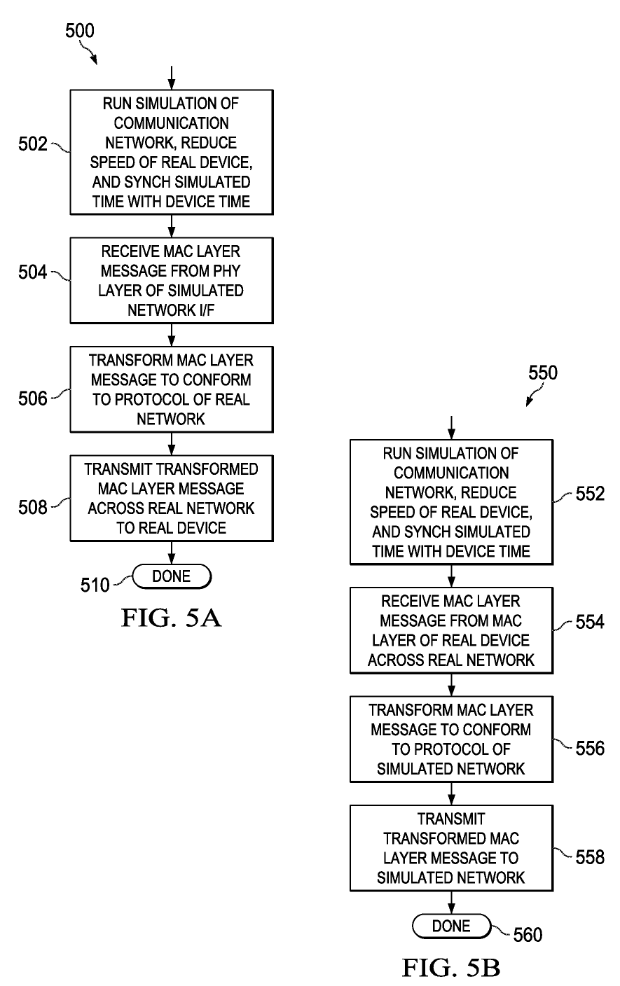

FIG. 5A shows a method 500 for bridging MAC layer messages from a simulated network, across a real network, to a real communication device, in accordance with at least some illustrative embodiments. After beginning execution of a network simulation, reducing the clock speed of the real communication device being tested, and synchronizing the passage simulated passage of time with the passage of time as measured by the real device (block 502), a MAC layer message is received from the PHY layer of a simulated network interface that interacts with a simulated communication network (block 504). The MAC layer message from the simulated network interface is transformed into a MAC layer message that conforms to a communication protocol associated with a real communication network (block 506). In at least some illustrative embodiments, the transformation includes encapsulating the MAC layer message from the simulated network within the data field of the transformed MAC layer message. In other illustrative embodiments, the transformation includes replacing at least some fields of the header of the MAC layer message from the simulated network with at least some different fields associated with the transformed MAC layer message. The transformed MAC layer message is transmitted across the real network to the real communication device (block 508), completing the method (block 510).

FIG. 5B shows a method 550 for bridging MAC layer message from a real communication device, across a real network, to a simulated network, in accordance with at least some illustrative embodiments. After beginning execution of a network simulation, reducing the clocks speed of the real communication device being tested, and synchronizing the passage simulated passage of time with the passage of time as measured by the real device (block 552), a MAC layer message is received from the real communication device across a real network (block 554). The received MAC layer message is transformed into a MAC layer message that conforms to a protocol associated with a simulated network within the network simulation (block 556). In at least some illustrative embodiments, the transformation includes unencapsulating the MAC layer message from within MAC layer message received from the real device. In other illustrative embodiments, the transformation includes replacing at least some fields of the header of the MAC layer message from the real device with at least some different fields associated with the transformed MAC layer message. The transformed MAC layer message is then transmitted to the simulated network (block 558) completing the method (block 560).

The above disclosure is meant to be illustrative of the principles and various embodiments of the present invention. Numerous variations and modifications will become apparent to those skilled in the art once the above disclosure is fully appreciated. For example, although the embodiments presented describe a simulated cellular telephone communication network, other embodiments may include other simulated wireless or wired networks, or combinations of simulated wired and wireless networks. Also, although the real and simulated networks of the embodiments shown and described utilize different communication protocols and technologies (e.g., wired and wireless; Ethernet and cellular telephone), other embodiments may include real and simulated networks that use the same protocol and the same technology. It is intended that the following claims be interpreted to embrace all such variations and modifications.

What is claimed is:

1. A communication network bridge, comprising:
a processor that executes simulation software that implements a simulated network, and further implements a simulated network interface that provides a communication path to the simulated communication network; and
a real network interface that provides a communication path to a real communication network;
wherein a first media access control (MAC) layer message that conforms to a protocol associated with the real communication network is received by the real network interface from across the real communication network; and
wherein the first MAC layer message is transformed by a first transformation operation into a second MAC layer message that is forwarded to a physical (PHY) layer of the simulated network interface.

2. The communication bridge of claim 1, wherein a third media access control (MAC) layer message from a PHY layer of the simulated network interface is transformed by a second transformation operation into a fourth MAC layer message conforming to a protocol associated with the real communication network, the second MAC layer message transmitted by the real network interface across the real communication network.

3. The communication bridge of claim 2, wherein the second transformation operation is the functional inverse of the first transformation operation.

4. The communication bridge of claim 1, wherein the first transformation operation comprises an decapsulation of the second MAC layer message from within the first MAC layer message.

5. The communication bridge of claim 1, wherein the first transformation operation comprises replacing at least part of a header of the first MAC layer message with at least part of a header of the second MAC layer message.

6. The communication bridge of claim 1, wherein one or more timeouts associated with the second MAC layer are increased in length such that processing delays, associated with the execution of the software that implements the simulated network, are shorter than the one or more timeouts.

7. A system, comprising:
a communication device comprising a first real network interface;
a computer system comprising:
a processor executing simulation software that implements a simulated communication network;
a second real network interface coupled to the processor; and
a communication network bridge comprising at least part of the second real network interface, and further comprising a message bridging function implemented at least in part by the simulation software; and
a real communication network that couples to both the first and second real network interfaces;
wherein the communication network bridge provides transparent bridging of a first media access control (MAC) layer message exchanged between the communication device and a physical (PHY) layer of a simulated network interface to the simulated communication network.

8. The system of claim 7, wherein the first MAC layer message is transferred across the real communication network within a second MAC layer message that encapsulates the first MAC layer message.

9. The system of claim 8, wherein the first MAC layer message is formatted to conform to a protocol associated with the simulated communication network and the second MAC layer message is formatted to conform to a protocol associated with the real communication network.

10. The system of claim 7,
wherein at least part of a first header of the first MAC layer message is replaced with at least part of a second header of a second MAC layer message before the second MAC layer message is transmitted across the real communication network; and
wherein at least part of the second header of the second MAC layer message is replaced with at least part of the first header of the first MAC layer message after the second MAC layer message is transmitted across the real communication network.

11. The system of claim 10, wherein the first MAC layer message is formatted to conform to a protocol associated with the simulated communication network and the second MAC layer message is formatted to conform to a protocol associated with the real communication network.

12. The system of claim 7, wherein operations performed by the communication device are performed at a rate that is slower than the normal operating speed specified for the communication device, the slower speed selected such that a delay in a message transaction between the communication device and the PHY layer of the simulated network interface, introduced as a result of the processing time required by the simulation software, does not cause a MAC layer timeout.

13. The system of claim 12, wherein simulated time, as represented by the simulation software, is stepped at intervals that are synchronized with the passage of time as measured by the communication device.

14. The system of claim 7, wherein the first real network interface is enabled during testing of the communication device and disabled during normal operation of the communication device.

15. The system of claim 7, wherein the simulated communication network comprises one or more simulated communication devices that interact with the simulated communication network and with the real communication device.

16. A method, comprising:
executing software that implements a simulated communication network, and further implements a simulated network interface to the simulated communication network;
receiving a first media access control (MAC) layer message from a physical (PHY) layer of the simulated network interface;
transforming the first MAC layer message into a second MAC layer message conforming to a protocol associated with a real communication network; and
transmitting the second MAC layer message across the real communication network to a real communication device.

17. The method of claim 16, further comprising:
receiving a third MAC layer message from the real communication device, the third MAC layer message conforming to the protocol associated with the real communication network;
transforming the third MAC layer message into a fourth MAC layer message; and
transmitting the fourth MAC layer message to the PHY layer of the simulated network interface.

18. The method of claim 17, further comprising:
a real communication device receiving the second MAC layer message and transmitting the third MAC layer message;
operating the real communication device in a test mode at a reduced speed relative to the speed at which the real communication device is operated when not in a test mode; and
adjusting one or more MAC layer timeouts in proportion to the reduction in operating speed of the communication device.

19. The method of claim 18, further comprising synchronizing simulated time, as represented by the software, with the passage of time as measured by the real communication device.

20. The method of claim 17, wherein the fourth MAC layer message is unencapsulated from within the third MAC layer message after receiving the third MAC layer message.

21. The method of claim 17, wherein at least part of a header of the third MAC layer message is replaced with at least part of a header of the fourth MAC layer message after receiving the third MAC layer message.

22. The method of claim 16, wherein the first MAC layer message is encapsulated within the second MAC layer message before transmitting the second MAC layer message.

23. The method of claim 16, wherein at least a part of a header of the first MAC layer message is replaced with at least part of a header of the second MAC layer message before transmitting the second MAC layer message.
